(19) United States
(12) Patent Application Publication
(10) Pub. No.: US 2007/0176326 A1
(43) Pub. Date: Aug. 2, 2007

(54) Method for filling polymer blanks into molds and an apparatus thereof

(76) Inventor: Fa-Shen Chen, Taichung City (TW)

Correspondence Address: TROXELL LAW OFFICE, 5205 LEESBURG PIKE, SUITE 1404, FALLS CHURCH, VA, 22041, US

(21) Appl. No.: 11/344,173

(22) Filed: Feb. 1, 2006

(51) Int. Cl. B29C 41/02; B29C 41/36

(52) U.S. Cl. 264/297.5; 264/297.7; 425/406

(57) ABSTRACT

A method for filling polymer blanks into molds and an apparatus thereof. The method includes steps of picking a predetermined amount of blanks formed with predetermined shapes; locating the blanks to fixedly space the blanks from each other by predetermined distances corresponding to the distances between the mold cavities of the molds, in which the blanks are to be filled; and respectively filling the blanks into the mold cavities of the molds. The apparatus includes at least one mold unit having at least one closable mold cavity for receiving a predetermined amount of blanks; and a picking/feeding unit disposed on one side of the mold unit. The picking/feeding unit includes a blank-picking section for picking a predetermined amount of blanks and locating the blanks in predetermined positions. The picking/feeding unit further includes a blank-feeding section for driving the blank-picking section to move and feed the blanks picked by the blank-picking section into the mold cavity.

### BACKGROUND OF THE INVENTION

The present invention is related to a polymer molding technique, and more particularly to a method for filling polymer blanks into molds and an apparatus thereof.

In the conventional polymer molding technique, in some cases, the polymer materials are quantitatively filled into the mold cavity of a mold by means of a proper processing apparatus. Through chemical reaction, the polymer materials are coupled and molded. In some other cases, a blank is previously quantitatively formed of the polymer materials. Then the blank is placed into the mold cavity of the mold. Through chemical reaction, the blank is molded into a product.

With respect to the forming of the blank, the blanks are previously quantitatively formed of the polymer materials with a certain shape. Then the separate blanks are humanly respectively filled into the mold cavities of the molds. Such operation necessitates great cost for labors. Also, the quality of the products cannot be ensured. Therefore, the above technique is not economic and competitive.

### SUMMARY OF THE INVENTION

It is therefore a primary object of the present invention to provide a method for filling polymer blanks into molds. By means of the method, the separate blanks can be quickly and accurately filled into the mold cavities of the molds. Therefore, the production efficiency is enhanced and the quality of the products can be ensured.

It is a further object of the present invention to provide an apparatus for filling polymer blanks into molds. The apparatus includes a picking/feeding unit which can quickly fill the separate blanks into the mold cavities of the molds. Therefore, the working time is shortened and the production efficiency is enhanced.

According to the above objects, the method for filling the polymer blanks into the molds includes steps of picking a predetermined amount of blanks formed with predetermined shapes; locating the blanks to fixedly space the blanks from each other by predetermined distances corresponding to the distances between the mold cavities of the molds, in which the blanks are to be filled; and respectively filling the blanks into the mold cavities of the molds. The apparatus includes at least one mold unit having at least one closable mold cavity for receiving a predetermined amount of blanks; and a picking/feeding unit disposed on one side of the mold unit. The picking/feeding unit includes a blank-picking section for picking a predetermined amount of blanks and locating the blanks in predetermined positions. The picking/feeding unit further includes a blank-feeding section for driving the blank-picking section to move and feed the blanks picked by the blank-picking section into the mold cavity.

The present invention can be best understood through the following description and accompanying drawings wherein:

### BRIEF DESCRIPTION OF THE DRAWINGS

FIG. 1 is a top view of the a preferred embodiment of the apparatus for filling the polymer blanks into the molds of the present invention;

FIG. 2 is a front view of the preferred embodiment of the apparatus for filling the polymer blanks into the molds of the present invention;

FIG. 3 is a right view of the preferred embodiment of the apparatus for filling the polymer blanks into the molds of the present invention; and

FIG. 4 is a partially left view of the preferred embodiment of the apparatus for filling the polymer blanks into the molds of the present invention.

### DETAILED DESCRIPTION OF THE PREFERRED EMBODIMENTS

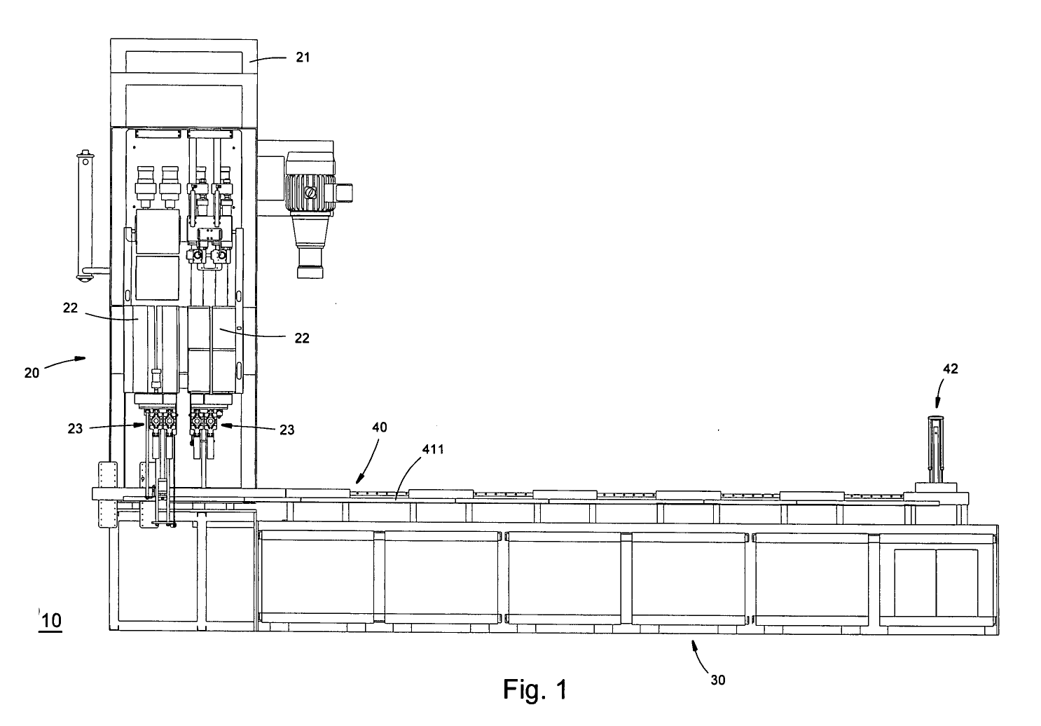

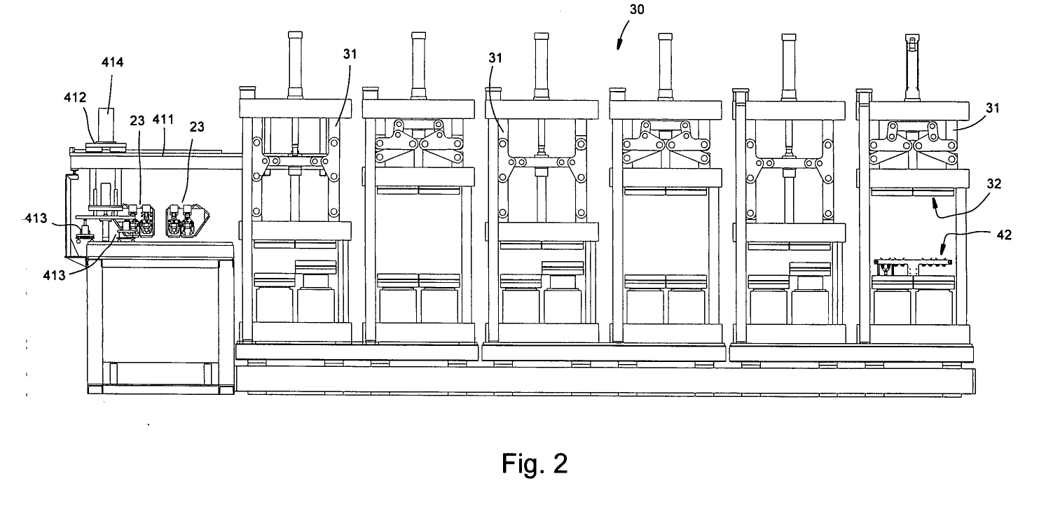

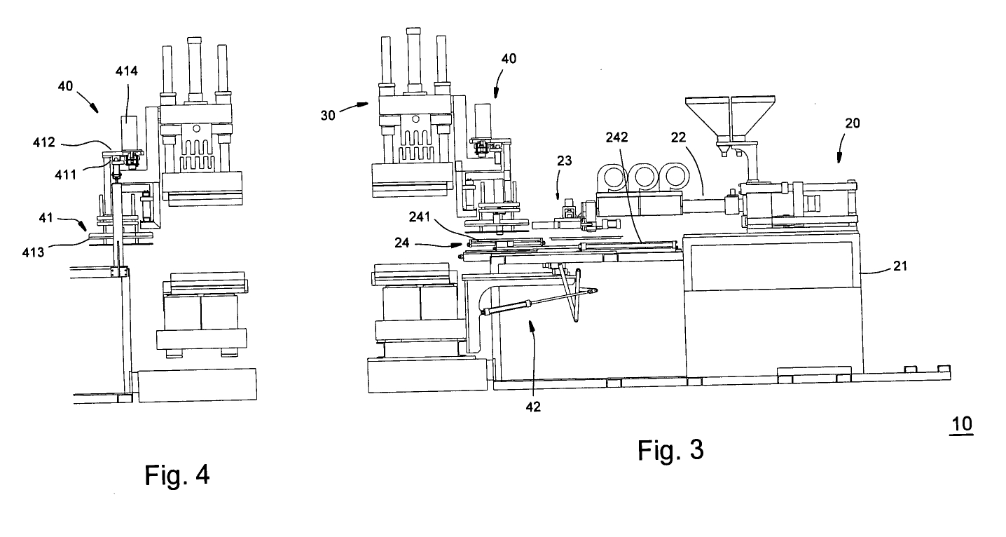

Please refer to FIGS. 1 to 4. The apparatus 10 for filling polymer blanks into molds of the present invention includes a blank-forming unit 20, several mold units 30 and a picking/feeding unit 40.

The blank-forming unit 20 includes a base body 21 and two injection molding devices 22 parallelly arranged on the base body 21. Each injection molding device 22 has an extrusion barrel 221. Two molding sections 23 are respectively disposed at the material-releasing ends of the extrusion barrels 221. The materials are extruded from the extrusion barrels 221 of the injection molding devices 22 respectively into the blank mold cavities of the molding sections 23 and previously molded into blanks with a certain geometric shape. This technique has been disclosed in Application No. 200520001747.5 of this applicant and thus will not be further described hereinafter. Two blank-carrying sections 24 are respectively positioned under the two molding sections 23 for carrying the blanks molded by the molding sections 23 and demolded downward.

To speak in more detail, each blank-carrying section 24 has an elongated carrying tray 241 lengthwise slidably disposed on the base body 21 and linearly reciprocally movable between a carrying position and an outgoing position. A driving member 242 serves to drive the carrying tray 241 to reciprocally move between the carrying position and the outgoing position. Accordingly, when the carrying tray 241 is positioned in the carrying position, the carrying tray 241 can carry the blank dropping from the corresponding molding section 23. When moving to the outgoing position, the carrying tray 241 carries the blank to one side of the corresponding molding section 23, where the picking/feeding unit 40 picks the blank of the carrying tray 241. It should be noted that when the carrying tray 241 is moved from the carrying position to the outgoing position, the carrying tray 241 can sequentially carry multiple blanks molded by the corresponding molding section 23.

Each mold unit 30 is composed of a mold holder 31 and a mold 32. The mold units 30 are linearly arranged on one side of the blank-forming unit 20 to form multiple stations. The blanks are respectively placed in certain positions in the mold cavities of the molds 32 and molded into the necessary shapes. The mold units 30 pertain to prior art and thus will not be further described hereinafter.

The picking/feeding unit 40 is disposed between the blank-forming unit 20 and the mold units 30. The picking/feeding unit 40 includes a blank-picking section 41 for picking the blanks molded by the blank-forming unit 20 and multiple blank-feeding sections 42 for respectively feeding the blanks picked by the blank-picking section 41 into the mold cavities of the mold unit 30. Therefore, the blanks can be automatically filled into the mold cavities.

The blank-picking section 41 has a rail 411 built on one side of the mold units 30 in parallel to the linearly arranged stations. A seat body 412 is slidably mounted on the rail 411 and reciprocally movable along the rail 411 between the mold units 30 and the blank-forming unit 20. A blank-carrying member 413 is fixedly disposed under the seat body 412. The blank-carrying member 413 has a sharp needle-like picking end which can thrust into the blank and pick the blank. The blank-carrying member 413 has been disclosed in Application No. 200520001745.6 of this applicant and thus will not be further described hereinafter. A power member 414 serves to provide power for sliding the seat body 412 and the blank-carrying member 413 on the rail 411 at a certain speed.

The blank-feeding section 42 has been disclosed in Taiwanese Utility Model Patent No. 92216935.

The method for filling polymer blanks into molds of the present invention is performed by means of the apparatus 10 for filling polymer blanks into molds of the present invention.

The blank-forming unit 20 molds the polymer materials into multiple blanks with a certain shape. The blank-carrying sections 24 carry the blanks to one open side of the corresponding molding sections 23 under the rail of the picking/feeding unit. Accordingly, the sharp picking end of the blank-carrying member 413 of the picking/feeding unit 40 can downward thrust into a certain amount of blanks and pick up the blanks. The picking ends are previously located. Therefore, when picking up the blanks, the blanks are also located and spaced from each other by a predetermined distance. The distance between the blanks corresponds to the distance between the mold cavities in which the blanks are to be filled.

Then, the power member 414 drives the seat body 412 to move along the rail 411 to the position of the mold unit. At this time, the blank of the blank-carrying member 413 is downward released and accepted by the blank-feeding section 42. The blank-feeding section 42 then feeds the blank into the mold cavity of the corresponding mold unit. After the blank-carrying member 413 releases the blank, next blank-picking operation is performed.

According to the above method and apparatus of the present invention, the blanks can be quickly and accurately filled into the mold cavities without errors. One single blank-forming unit is combined with multiple-station mold units to reduce the occupied room and lower the cost. Also, the working time is shortened and the production efficiency is enhanced.

The above embodiments are only used to illustrate the present invention, not intended to limit the scope thereof. Many modifications of the above embodiments can be made without departing from the spirit of the present invention.

What is claimed is:

1. A method for filling polymer blanks into molds, comprising steps of:
picking a predetermined amount of blanks formed with predetermined shapes;
locating the blanks to fixedly space the blanks from each other by predetermined distances corresponding to the distances between the mold cavities of the molds, in which the blanks are to be filled; and
respectively filling the blanks into the mold cavities of the molds.

2. The method for filling the polymer blanks into the molds as claimed in claim 1, wherein before picked, the blanks are collectively positioned in a predetermined position.

3. The method for filling the polymer blanks into the molds as claimed in claim 1, wherein there are a plurality of molds in which the blanks are filled.

4. The method for filling the polymer blanks into the molds as claimed in claim 3, wherein the molds are linearly sequentially arranged.

5. An apparatus for filling polymer blanks into molds, comprising:
at least one mold unit having at least one closable mold cavity for receiving a predetermined amount of blanks; and
a picking/feeding unit disposed on one side of the mold unit, the picking/feeding unit including a blank-picking section for picking a predetermined amount of blanks and locating the blanks in predetermined positions, the picking/feeding unit further including a blank-feeding section for driving the blank-picking section to move and feed the blanks picked by the blank-picking section into the mold cavity.

6. The apparatus for filling the polymer blanks into the molds as claimed in claim 5, wherein the blank-feeding section has a rail extending along one side of the mold unit, a seat body being slidably mounted on the rail and fixedly connected with the blank-picking section, a blank-carrying member being disposed on the seat body for picking the blanks, a power member serving to drive the seat body to move along the rail.

7. The apparatus for filling the polymer blanks into the molds as claimed in claim 5, wherein the blank-carrying member has a predetermined number of picking ends for picking the blanks.

8. The apparatus for filling the polymer blanks into the molds as claimed in claim 7, wherein the picking ends are sharp ends for thrusting into the blanks.

9. The apparatus for filling the polymer blanks into the molds as claimed in claim 5, further comprising a blank-forming unit for molding the polymer materials into the blanks with predetermined shapes.

10. The apparatus for filling the polymer blanks into the molds as claimed in claim 9, wherein the picking/feeding unit is disposed between the blank-forming unit and the mold unit.

11. The apparatus for filling the polymer blanks into the molds as claimed in claim 9, wherein the blank-forming unit includes at least one molding section for molding the polymer materials into blanks with predetermined shapes and at least one blank-carrying section for carrying the blanks molded by the molding section, the blank-carrying section being movable between a carrying position and an outgoing position, whereby when the blank-carrying section is positioned in the carrying position, the blank-carrying section is positioned under the molding section for accepting the blank dropping from the molding section, while when the blank-carrying section moves to the outgoing position, the blank-carrying section carries the blank to the outgoing position where the picking/feeding unit picks the blank from the blank-carrying section.
